(19) United States
(12) Patent Application Publication
(10) Pub. No.: US 2018/0293996 A1
(43) Pub. Date: Oct. 11, 2018

(54) Electronic Communication Platform

(71) Applicant: Connected Digital Ltd, Newbury (GB)

(72) Inventors: Alan Mortis, Newbury (GB); Miroslaw Krymski, Rzeszow (PL)

(21) Appl. No.: 15/484,771

(22) Filed: Apr. 11, 2017

(51) Int. Cl. G10L 21/10; G10L 15/26; G06F 17/21; G10L 15/30; G10L 21/0272; G10L 17/00; G10L 15/06; H04L 29/06

(52) U.S. Cl. CPC G10L 21/10; G10L 15/265; G06F 17/218; H04L 65/403; G10L 21/0272; G10L 17/005; G10L 15/063; G10L 15/30

(57) ABSTRACT

An electronic communication platform for audio- or video- conferencing is provided. Audio (video) streams are transmitted from client stations to a central media server, which re-transmits the streams to all other stations, and also makes a recording of each individual stream. The individual stream recordings are then transcribed by a transcription engine. Transcribed text is split into snippets, with each snippet being marked with a timestamp corresponding to the point in the audio (video) recording where the words of the snippet were spoken. The transcribed text is displayed on a user interface, optionally interspersed with text chat, file transfers, and other content, for selectably playing back relevant parts of the audio (video) recording based on selected snippets.

### BACKGROUND

There are numerous services and programs which allow multi-party audio (and optionally video) communication, i.e. telephone conferencing or video conferencing systems. These systems commonly operate over the internet or another computer network in some way. Examples of common services include Skype® and GoToMeeting®. They allow simultaneous broadcast of an audio (video) stream from each user to every other user in a group conversation. Various protocols and architectures are used to realise these systems. Specifically, some systems use a “peer-to-peer” model where audio (video) streams are sent directly between client stations. Others use a centralised model where audio (video) streams are sent via a central media server.

Often, text chat is integrated into these systems so that written text messages can be sent and received between users, while an audio (video) conference is underway. This can be a useful augmentation to an audio (video) conference, combining the best features of a real-time audio (video) conference with the ability to copy-and-paste snippets of relevant text, clarify the spelling of words etc. which is easier over text chat. It is often possible to share photos and other files as well during the conversation.

Although it is typically possible to record calls held over known systems, the recordings are often of low value as a useful record of what went on. Although the text chat may be searchable, the bulk of the conversation over the audio channel usually is not. It is therefore a time consuming process to go back through recorded conversations to identify whether there is relevant material (for a particular purpose) in those conversations and to find the particularly relevant sections to play back.

It is an object of the invention to provide a more useful record of an audio (video) group conversation.

### SUMMARY OF THE INVENTION

According to the present invention, there is provided a system for group audio communication over a network, the system comprising;
at least two client stations, each client station having at least a microphone for audio input and a speaker for audio output;
and a central media server,

each client station being adapted to transmit an audio stream from the microphone to the central media server and the central media server being adapted to re-transmit the received audio streams to each other client station for reproduction on the speaker of each client station,

the central media server including a recording module adapted to record and store each audio stream individually,

and the central media server further including a transcription module adapted to transcribe spoken audio from each audio stream to create a text record of the audio stream, and to tag the text record with references to relevant time periods in the audio stream,

each client station being further adapted to receive the transcribed text record of the audio streams from the media server, and each client station being provided with a user interface allowing playback of the recorded audio streams starting at a time in the recording determined by a user-selected part of the text record.

The system of the invention allows a group of users to hold a teleconference call in the usual way. As well as audio streams, many embodiments will allow some combination of video, text chat, file transfer, screen sharing and other multimedia communication features during the conference.

After a conversation has been completed, users are able to find and play back relevant parts of the conversation easily. The transcribed text record is preferably searchable via the user interface, and so even in a long conversation, or multiple conversations, the relevant part can be found quickly by searching for key words. By searching for the relevant part of the conversation in the transcribed text record, the user can jump directly to the relevant part of the audio (video) recording by selecting that part of the text record for playback.

Due to imperfections in automated transcription engines, and also because even perfectly transcribed spoken conversation is often difficult to read, the system allows playback of the best possible record of the conversation, i.e. the audio (video) recording, but combines this with the advantage of easy searching in the transcribed text record. As a result, the system of the invention provides users with a more useful record of audio (video) conferences than presently available systems, allowing them to jump directly to exactly the right place when playing back an audio (video) recording.

The recordings of the audio (video) streams may be downloaded to client stations after the end of the conversation for possible playback. Alternatively, duplicate recordings of each stream may be made on each client station and also the media server at the time the conversation takes place. As a further alternative, the recordings may remain on the central media server until such time as playback is required, at which point the desired part of the recording can be requested and retrieved on demand, in near-real-time (i.e. “streamed” to the client station).

The transcription module on the central media server may be a transcription engine of a known type, running on the central media server itself. Alternatively, the role of the transcription module on the central media server maybe simply to act as an interface with an external transcription engine. For example, cloud-based transcription services are provided commercially by, amongst others, Microsoft® and Google®. An externally provided transcription engine or service may be completely automated, or a premium service might include human checking and correcting of an automated transcription output.

In one embodiment, the transcription module includes the facility to split transcribed text into snippets. Typically, the start of a new snippet might be identified by pauses in speech from the audio recording. Where a video stream is available, it is even possible that video cues might be used to identify a new snippet. Alternatively, the breaks between snippets may be identified purely by analysis of the transcribed text, using known text processing techniques. Whatever method is used, the aim is to break down the transcribed text record so that each snippet relates to a single short intelligible idea. Typically, attempting to split the text into sentences would be suitable.

Each snippet may then be tagged with a timestamp, i.e. a reference to a start time on the recording where the original audio is relating to that text snippet. This allows easy playback of exactly the right part of the original audio, by selecting the relevant snippet.

Although transcription takes place on individual audio streams, where it is generally expected that a single person would be speaking on each stream, in some embodiments multiple streams may be taken into account when determining how to split the transcribed text record into snippets. For example if a person speaking gets interrupted during the conversation, or even another person says “yes” or makes an acknowledgement, then that may be a good cue to mark the beginning of a new snippet. Dividing transcribed text into snippets in this way also allows the flow of the whole conversation to be displayed more usefully.

As an alternative to attempting an “intelligent” split of the transcribed text record into snippets, a simple embodiment could simply tag the transcribed text record (effectively defining a new snippet) based on time or word count. For example, a snippet could be defined simply as, for example, 12 words or 12 seconds of spoken audio.

The user interface preferably displays the transcribed text records of multiple audio streams, for multiple parties in a conversation, in a single conversation thread view. Because the transcription engine works on individual audio streams, allocation of each transcribed snippet to a particular participant in the conversation is straightforward. Because each snippet is provided with a timestamp, the snippets can be correctly arranged in chronological order so that the flow of the conversation is apparent

Preferably, where text chat, file upload, screen sharing or other features are used during the audio (video) group conversation, a record of the text chat, files uploaded, screen shots etc. may be provided, chronologically as part of the conversation view, together with text snippets transcribed from the multiple audio streams.

In some embodiments, an email system may be integrated so that email correspondence sent between users can be displayed alongside the transcribed audio and other “real time” conversation material as described above.

Where there is a video stream accompanying the audio streams, stills from the video may be provided at points in the conversation view. Some embodiments may analyse the video stream to detect significant changes. For example, in many group conversations the video streams will comprise a single person facing the camera and either talking or listening for large sections. However, a significant change may indicate something more interesting, for example a demonstration or a different speaker coming into the frame. Detecting these changes may be a useful way to determine the points at which stills from the video may be injected into the conversation view.

It is envisaged that simple embodiments will take completed recordings of the audio streams, after the conversation has been completed, and the transcription engine will be applied to completed recordings of individual streams. This may enhance the accuracy of the transcription process firstly because the processing time taken to transcribe each recording is not so critical, and so more time-consuming algorithms can be applied, and also because the transcription engine is able to use the whole recording when determining the most likely accurate transcription of particular parts. For example, if a particular word near the beginning of the stream is unclear, then likely candidates can be narrowed down by taking into account the overall subject of the conversation, taking into account later parts of the audio stream and possibly also transcriptions from other speakers in the conversation. An iterative process may be used where each audio stream is transcribed individually, and then any uncertain sections (or even whole streams) may be run through the transcription engine again, this time taking into account the apparent subject of the conversation, or common words and themes.

The transcription engine may also have available historical recordings of the same speaker, in combination with previous transcriptions which may have been manually corrected and/or parts confirmed as accurate.

In some embodiments, a first-pass transcription attempt may use a general-purpose transcription engine, but if a specialist subject (e.g. legal, medical) is identified then a specialist transcription engine, or specialist dictionary/plugin may be identified and used for a second transcription attempt which is focused on the particular identified subject matter. Alternatively, a specialist transcription engine or a specialist dictionary/plugin may be pre-specified by the user.

Furthermore, some embodiments may use text chat, uploaded files and other non-audio content of the same conversation to provide context to the transcription engine and increase the accuracy of transcribed text.

As an alternative, in some embodiments it may be preferable to transcribe the call in near-real time. In some scenarios, immediate availability of the transcription is valuable, even if it means a reduction in quality. In these embodiments, it is possible to optionally re-run the transcription process in slower time to improve quality.

Once playback of the conversation via the user interface has begun, by selecting a particular text snippet in the conversation view, the audio (video) streams are played back from the particular timestamp associated with the selected snippet. As the conversation progresses, relevant text snippets in the conversation view are preferably highlighted during playback.

In some embodiments, the user interface may allow users to correct inaccuracies in the transcribed text. Such corrections may be made available to other users.

Whether or not corrected, the user interface may also provide the facility for a user to mark individual parts of the transcribed text as accurate. The accuracy markings may be made available to other users over the network. The user interface may mark snippets or whole conversations to indicate where the accuracy has been agreed by one or more users. Corrections may optionally be fed back into the transcription engine to improve future quality.

Where snippets or whole conversations are agreed as accurately transcribed by one or more users, this may feed into a data retention process. For example, unless marked as particularly important, the original audio and video recordings might be deleted as soon as a transcription has been agreed, or given a shorter retention period than audio and video recordings where the transcription has not been reviewed or agreed. It is envisaged that any retention process will be configurable to meet the users' particular business needs.

It is envisaged that in most cases client stations will be desktop, laptop or tablet computers, or smartphones. All these devices are commonly used with known group conferencing platforms, and all of them have the hardware required not only to take part in the conversation in the first place, but to provide a user interface for display of the transcribed conversation and playback of selected parts of the recorded conversation.

As with known group conferencing platforms, it may be possible to use an ordinary telephone to take part in the conversation by dialling in to a gateway number. In this case, the user interface for later display of the transcribed conversation will need to be provided on an alternative device, in other words, the client station with the microphone and speaker used for taking part in the conversation would usually, but not necessarily, be the same physical device as the client station with the user interface used for browsing and playing-back the recorded and transcribed conversation.

In some embodiments, a voice identification module may be provided for identifying a speaker in an audio recording. The voice identification module may build up a database of voice “signatures” for each regular user. The voice signatures may be generated and stored in the database as a result of a specific user interaction, i.e. the user specifically instructing the system to generate and store a voice signature, or alternatively might be generated automatically when the system is used in the normal way. These signatures can then be used in various ways. For example, voice could be used as an additional security factor when signing into the system. Voice may also be used to authenticate a particular speaker to other conversation participants, by generating a warning when the speaker's voice signature does not appear to match the identity of the signed-in user.

Voice signatures may also be used where a single audio stream includes multiple speakers, to attempt to split out transcribed text and appropriately attribute each individual snippet to the correct speaker. It may happen that multiple people are sat around the same computer taking part in a group conversation, and so although the system has access to an individual audio stream from an individual client station, this does not necessarily equate in all cases to one audio stream per speaker.

When a voice is heard by the system that does not match the current logged in user, the system can search the database for a probably match, for example searching for users with a similar voice signature and also taking into account connections with the logged in user, for example a shared conversation history or shared contacts.

The system of the invention provides the advantages of real-time natural conversation which are associated with voice (and video) conferencing, combined with the advantages of easy searching and identification of relevant parts which are associated with written text-based conversation.

### BRIEF DESCRIPTION OF THE DRAWING

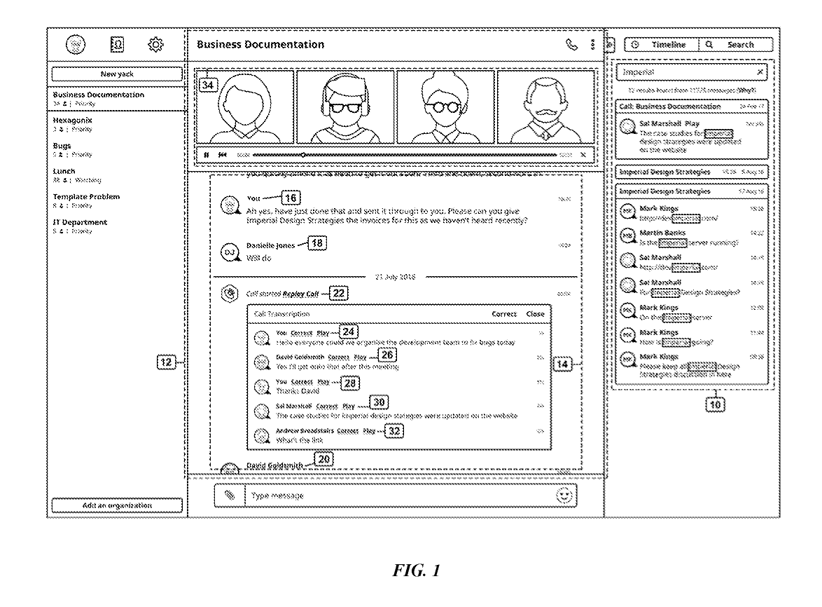

For a better understanding of the invention, and to show how it may be put into effect, an embodiment will now be described with reference to appended FIG. 1, which shows an example user interface on a client station being used to search through and play back a recorded conversation.

### DETAILED DESCRIPTION

Multiple conversations with multiple groups of people, going back some time, are likely to be stored in typical embodiments. Therefore the user interface offers several features to easily find the desired relevant conversation. For example, an advanced search could be used to find conversations during a certain date range, including certain people, in combination with particular keywords in the conversation text. In the example pictured, a straightforward search interface is shown at 10. The user is searching for conversations which include the keyword “imperial”. Several matches have been found and can be selected from the area directly below the search box.

Once a conversation has been selected, the conversation will appear in the main central pane of the interface, indicated at 12. The lower part 14 of the pane 12 shows the historical thread of the conversation. In the example, a section of the conversation is shown which extends to earlier time periods by scrolling up the screen and later time periods by scrolling down the screen. The conversation history includes text chat components 16, 18, 20 as well as transcribed parts of a video call 22. The transcribed video call 22 comprises a plurality of transcribed text snippets 24, 26, 28, 30, 32. A “play” button appears in line with each snippet. Pressing the play button will start playback of the original video call, in the playback pane 34 near the top of the screen. Playback will begin at a timestamp on the video call associated with the particular snippet selected. As playback progresses, the appropriate snippets are highlighted. In FIG. 1, snippet 30 is currently highlighted.

Note that the transcribed part 22 shown in FIG. 1 is a transcription of only a part of the recorded video call. The last transcribed snippet 32 reads “what's the link”, which is a question most easily answered by text chat. The next part of the conversation is therefore a written text message, the top of which is just visible at the bottom of the central pane 12. The video stream is continuing, and when one of the participants speaks again transcribed text will appear, interspersed with any written text messages.

It will be appreciated that the embodiment described, and in particular the specific user interface shown in FIG. 1, are by way of example only. Changes and modifications from the specific embodiments of the system described will be readily apparent to persons having skill in the art. The invention is defined in the claims.

1. A system for group audio communication over a network, the system comprising:
at least two client stations, each client station having at least a microphone for audio input and a speaker for audio output;
and a central media server,
each client station being adapted to transmit an audio stream from the microphone to the central media server and the central media server being adapted to re-transmit the received audio streams to each other client station for reproduction on the speaker of each client station_{;}
the central media server including a recording module adapted to record and store each audio stream individually,
and the central media server further including a transcription module adapted to transcribe spoken audio from each audio stream to create a text record of the audio stream, and to tag the text record with references to relevant time periods in the audio stream_{;}
each client station being further adapted to receive the transcribed text record of each audio stream from the media server, and each client station being provided with a user interface allowing playback of the recorded audio streams starting at a time in the recording determined by a user-selected part of the text record.

2. A system for group audio communication as claimed in claim 1, in which the transcription module is further adapted to split transcribed text into snippets.

3. A system for group audio communication as claimed in claim 2, in which the transcription module is adapted to split transcribed text into snippets based on identifying pauses in the audio stream being transcribed.

4. A system for group audio communication as claimed in claim 2, in which the transcription module is adapted to split transcribed text into snippets by using text processing techniques to identify grammatical delimiters.

5. A system for group audio communication as claimed in claim 2, in which the transcription module is adapted to split transcribed text into snippets by identifying audio or visual cues in audio or visual streams other than the stream being transcribed, which were recorded as part of the same group conversation.

6. A system for group audio communication as claimed in claim 1, in which the user interface is adapted to display the transcribed text records of multiple audio streams, arranged chronologically in a single view.

7. A system for group audio communication as claimed in claim 6, in which at least one of text chat, file upload, and screen sharing is provided during the group conversation, and in which a record of the text chat, file upload, or screen sharing activity is provided in the user interface, chronologically and interspersed with the transcribed text records of the audio streams.

8. A system for group audio communication as claimed in claim 1, in which the transcription module is applied to completed recordings of individual streams, after the group conversation is completed.

9. A system for group audio communication as claimed in claim 8, where at least one of text chat and file upload is provided during the group conversation, and the contents of the text chat and/or file upload are provided to the transcription module after the conversation is completed, the transcription module using the contents of the text chat and/or file upload to enhance the accuracy of transcription.

10. A system for group audio communication as claimed in claim 1, in which the user interface provides the facility to correct transcribed text, and share corrected transcribed text with other client stations.

11. A system for group audio communication as claimed in claim 10, in which corrected transcribed text is fed back into the transcription module to improve future accuracy.

12. A system for group audio communication as claimed in claim 1, in which a voice identification module is provided for identifying a speaker in an audio recording.

13. A system for group audio communication as claimed in claim 12, in which the transcription module uses the voice identification module to attribute transcribed text to different speakers in the same audio stream.

14. A system for group audio communication as claimed in claim 1, in which playback of the recorded audio stream on a client station includes requesting the appropriate part of the original recording from the central media server, and streaming the appropriate part of the original recording to the client station for playback.

15. A method of recording and playing back a group audio communication held over a network, the method comprising:
providing at least two client stations_{;} each client station having at least a microphone for audio input and a speaker for audio output;
providing a central media server;
holding a group audio conversation whereby an audio stream from the microphone on each client station is transmitted to the central media server, and the central media server retransmits each audio stream to each other client station for reproduction on the speakers of the other client stations;
recording each audio stream individually on the central media server;
using a transcription module on the central media server to transcribe the recorded audio streams to create a transcribed text record of each audio stream, wherein the text record of each audio stream is tagged with references to relevant time periods in the audio stream,
transmitting the transcribed text record from the central media server to each client station;
displaying the transcribed text record on a user interface on each client station, the user interface allowing playback of the original audio streams starting at a time in the recording determined by a user-selected part of the transcribed text record.

16. A computer program on a non-transient computer-readable medium such as a storage medium, for controlling hardware to carry out the method of claim 15.
